(19) United States
(12) Patent Application Publication
(10) Pub. No.: US 2003/0029812 A1
(43) Pub. Date: Feb. 13, 2003

(54) Mixtures of free halogen-generating biocides, halogen stabilizers and nitrogen containing biocides in water treatment and papermaking applications

(75) Inventors: Thomas Warren Burns, Ridgewood, NJ (US); Christopher Hill, Wanaque, NJ (US); Richard Ashley Sinden, Kidderminster (GB); Philip Gerdon Sweeny, Hackettstown, NJ (US)

Correspondence Address: DARBY & DARBY P.C., P. O. BOX 5257, NEW YORK, NY, 10150-5257, US

(73) Assignee: LONZA INC.

(21) Appl. No.: 10/185,435

(22) Filed: Jun. 28, 2002

Related U.S. Application Data
(60) Provisional application No. 60/302,511, filed on Jun. 29, 2001.

(51) Int. Cl. C02F 1/68

(52) U.S. Cl. 210/764

(57) ABSTRACT

The present invention is a method for controlling (e.g. inhibiting) the growth of microorganisms or killing microorganisms in an aqueous solution, such as that found in a water treatment facility or papermaking facility. The method includes adding an effective amount of (a) a free halogen-generating biocide, (b) a halogen stabilizer, and (c) a quaternary ammonium compound, a biocidal amine or salt thereof, or mixture thereof to the aqueous solution. The aqueous solution may be water in a recreational facility, an industrial cooling system, a water treatment facility or a water slurry, such as a circulating water slurry, in a papermaking facility. The mixture of the present invention is useful as a slimicide. The quaternary ammonium biocide and/or biocidal amine increase the efficacy of the free halogen-generating biocidal system.

This application claims the benefit of U.S. Provisional Application No. 60/302,511, filed Jun. 29, 2001, which is hereby incorporated by reference.

### FIELD OF THE INVENTION

This invention relates to mixtures of (a) free halogen-generating biocides, (b) halogen stabilizers, and (c) a nitrogen containing biocide (quaternary ammonium biocides and/or biocidal amines) for controlling the growth of or killing microorganisms in aqueous solutions, such as water slurries in industrial and recreational water treatment and papermaking applications.

### BACKGROUND OF THE INVENTION

U.S. Pat. No. 5,565,109 discloses that selected N-hydrogen compounds, such as 5,5-dimethylhydantoin (DMH), and their chlorinated derivatives, improve the bactericidal efficacy of hypochlorite solutions in pulp slurries.

There is a continuing need for improved biocidal systems for aqueous solutions in water treatment and papermaking applications.

### SUMMARY OF THE INVENTION

The present invention is a method for controlling (e.g. inhibiting) the growth of microorganisms or killing microorganisms in an aqueous solution, such as that found in a water treatment facility or papermaking facility. The method includes adding an effective amount of (a) a free halogen-generating biocide, (b) a halogen stabilizer, (c) a quaternary ammonium compound, a biocidal amine or salt thereof, or mixture thereof, and optionally (d) a bromide source, to the aqueous solution. The quaternary ammonium compound may be (i) a quaternary ammonium biocide having the formula N⁺R¹R²R³R⁴ X⁻ where R¹ and R² are independently unsubstituted or hydroxy substituted linear or branched C₁-C₄ alkyl, —(CH₂CH₂O)ₘCH₂CH₂OH, or —(CH₂CHCH₃O)ₘCH₂CHCH₃OH where m is 1 to 10; R³ is a substituted or unsubstituted benzyl, (C₁-C₄ alkyl)benzyl (such as ethylbenzyl), (C₁-C₄ alkyl)naphthyl (such as methylnaphthyl), or linear or branched C₁-C₂₂ alkyl; R⁴ is —R⁵(O)ₙ(C₆H₅)R⁶ where n is 0 or 1; R⁵ is a substituted or unsubstituted C₁-C₈ alkyl or C₁-C₈ alkoxyalkyl; R⁶ is hydrogen or a substituted or unsubstituted, linear or branched C₁-C₁₂ alkyl; and X⁻ is an anoin, such as chloride, bromide, propionate, sulfate, bicarbonate, or carbonate;

(ii) a quaternary ammonium biocide having the formula R¹⁹R²⁰R²¹R²²N⁺X⁻, where R¹⁹, R²⁰, R²¹, and R²² are independently linear, branched, cyclic or any combination thereof saturated or unsaturated groups, X is an anion, and the sum of the number of carbon atoms in R¹⁹, R²⁰, R²¹, and R²² broadly ranges from about 10 to about 50;

(iii) a polymeric quaternary ammonium biocide; or

(iv) a mixture thereof.

The aqueous solution may be water in a recreational facility, an industrial cooling system, a water treatment facility or a water slurry, such as a circulating water slurry, in a papermaking facility. The mixture of the present invention is useful as a slimicide. The quaternary ammonium biocide and/or biocidal amine increase the efficacy of the stabilized halogen biocidal system. Furthermore, the halogen stabilizer improves both the photolytic and oxidative stability of the free halogen-generating biocide and the quaternary ammonium compound and/or biocidal amine.

### DETAILED DESCRIPTION OF THE INVENTION

The free halogen-generating biocide can be any known in the art, such as those described in U.S. Pat. No. 5,565,109, which is hereby incorporated by reference. According to one preferred embodiment, the free halogen-generating biocide is a slimicide. Suitable free halogen-generating biocides include, but are not limited to, hypochliorites, hypobromites, chlorine gas, bromine, bromine chloride, halogenated cyanurates, dihalogenated hydantoins, and mixtures thereof. Suitable hypochlorites include, but are not limited to, alkali metal hypochlorites (such as sodium hypochlorite), alkaline earth metal hypochlorites, and mixtures thereof.

A bromide source may also be added to the aqueous solution. Bromide compounds are significantly more stable than bromines. The bromide source can be any bromide containing material, such as sodium bromide, potassium bromide, ammonium bromide, hydrobromic acid, and the like. Upon mixing, the free halogen-generating biocide oxidizes the bromide source to form a bromine (which is also a free halogen-generating biocide).

Preferred free halogen-generating biocides include, but are not limited to, sodium hypochlorite and mixtures of sodium hypochlorite and sodium bromide.

The halogen stabilizer can be any known in the art, such as those described in U.S. Pat. No. 5,565,109. For example, the halogen stabilizer can be an N-hydrogen compound. Suitable N-hydrogen compounds include, but are not limited to, 5,5-dimethylhydantoin (DMH), glycouril, sulfamide, trisulfamide, p-toluene-sulfonamide, melamine, sodium triamidometaphosphate, 5,5-alkylhydantoins (such as 5-methyl-5-ethyl hydantoin (MEH)), methanesulfonamide, barbituric acid, 5-methyluracil, imidazoline, pyrrolidone, acetanilide, acetamide, N-ethylacetamide, phthalimide, benzamide, succinimide, cyanamide, urea, N-methylolurea, N-methylurea, acetylurea, biuret, methyl allophanate, methyl carbamate, phthalohydrazide, pyrrole, indole, formamide, N-methylformamide, dicyandiamide, ethyl carbamate, 1,3-dimethylbiuret, methyl phenyl biuret, 4,4-dimethyl-2-oxazolidinone, 6-methyluracil, 2-imidoazolidone, ethylene urea, 2-pyrimidone, N-ethylacetamide, azetidin-2-one, 2-pyrrolidone, caprolactam, phenyl sulfinimide, phenyl sulfinimidylamide, diphenyl sulfonimide, dimethyl sulfinimine, isothiazolene-1,1-dioxide, orthophosphoryl triamide, pyrophosphoryl triamide, phenyl phosphoryl-bis dimethyl amide, boric acid amide, hydantoin, pyrrole, sulfamic acid, ammonia, ammonium bromide, and mixtures thereof. Preferred halogen stabilizers include, but are not limited to, 5,5-dimethylhydantoin (DMH), 5-methyl-5-ethyl hydantoin (MEH), and mixtures thereof.

The quaternary ammonium biocide can have the formula N⁺R¹R²R³R⁴X⁻ where R¹ and R² are independently unsubstituted or hydroxy substituted linear or branched C₁-C₄ alkyl, —(CH₂CH₂O)ₘCH₂CH₂OH, or —(CH₂CHCH₃O)ₘCH₂CHCH₃OH where m is 1 to 10; R³ is a substituted or unsubstituted benzyl, ethylbenzyl, methylnaphthyl, or linear or branched C₁-C₂₂ alkyl; R⁴ is —R⁵(O)ₙ(C₆H₅)R⁶ where n is 0 or 1; R⁵ is a substituted or unsubstituted C₁-C₈ alkyl or C₁-C₈ alkoxyalkyl; R⁶ is hydrogen or a substituted or unsubstituted, linear or branched C₁-C₁₂ alkyl; and X⁻ is an anoin, such as chloride, bromide, propionate, sulfate, bicarbonate, or carbonate.

According to one preferred embodiment, R⁵ is preferably —CH₂CH₂OCH₂CH₂—. More preferably, R⁴ is [2-[2-(4-diisobutylphenoxy)ethoxy-ethyl]. According to another preferred embodiment, R⁴ is benzyl. Preferred quaternary ammonium biocides include, but are not limited to, salts of benzethonium ([2-[2-(4-diisobutylphenoxy)ethoxy]ethyl]dimethylbenzyl ammonium), such as benzethonium chloride (available as Hyamine 1622® from Lonza Inc. of Fair Lawn, N.J.); and salts of benzalkonium (benzyl alkyl dimethyl ammonium), such as benzalkonium chloride (available as Barquat® MB-50 and Barquat® MB-80 from Lonza Inc. of Fair Lawn, N.J.). Preferred benzalkonium salts include, but are not limited to, (C₁₂-C₁₈) alkyl benzyl dimethyl ammonium salts, such as (C₁₂-C₁₈)alkyl-benzyl dimethyl ammonium chloride.

According to yet another preferred embodiment, the anion X⁻ is carbonate:

Another suitable quaternary ammonium biocide has the formula R¹⁹R²⁰R²¹R²²N⁺X⁻, where R¹⁹, R²⁰, R²¹, and R²² independent are linear, branched, cyclic or any combination thereof saturated or unsaturated groups and X is an anion. The sum of the number of carbon atoms in R¹⁹, R²⁰, R²¹, and R²² broadly ranges from about 10 to about 50. R¹⁹, R²⁰, R²¹, and R²² may be alkyl, alkenyl, alkynyl, cycloalkyl, aryl, or any combination of any of the foregoing. X may be chloride, carbonate, bicarbonate, nitrile, bromide, iodide, acetate, dehydroacetate, laurate, stearate, carboxylate, or borate. Suitable carboxylate and borate anions include, but are not limited to, those disclosed in U.S. Pat. No. 5,641,726, which is hereby incorporated by reference.

A preferred quaternary ammonium compound has the formula R¹⁹(CH₃)₃N⁺X—, where R¹⁹ is a linear or branched C₁₀-C₂₀ saturated or unsaturated group, such as alkyl, alkenyl, or alkynyl group and X is defined as above. More preferably R¹⁹ is a linear C₁₆-C₁₈ saturated or unsaturated group and X is chloride, carbonate, or acetate. An example of such a compound is N-octadecyl-N,N,N-trimethylammonium chloride.

Another preferred quaternary ammonium compound has the formula R¹⁹R²⁰(CH₃)₂N⁺X—, where R¹⁹ is a linear or branched C₆-C₂₀ saturated or unsaturated group or C₆-C₂₀ substituted or unsubstituted aryl group, R²⁰ is a linear or branched C₁-C₂₀ saturated or unsaturated group or C₆-C₂₀ substituted or unsubstituted aryl group, and X is defined as above. The term “substituted” as used herein includes, but is not limited to, substitution with any one or any combination of the following substituents: C₁-C₄ alkyl. Preferably, R¹⁹ and R²⁰ independently are linear or branched C₈-C₁₅ saturated or unsaturated groups. In a more preferred embodiment, R¹⁹ and R²⁰ independently are linear or branched C₈-C₁₂ saturated or unsaturated groups and X is chloride, carbonate, or acetate. Special mention is made of didecyldimethylammonium chloride, which is available as Bardac® 2280 available from Lonza Inc. of Fair Lawn, N.J.; didecyldimethylammonium bicarbonate; and didecyldimethylammonium carbonate; and N,N-di(tetradecyl/pentadecyl)-N,N-dimethylammonium chloride, which is available as Carsoquat® 457 from Lonza Inc. (Carsoquat® 457 is a mixture of N-tetradecyl-N-pentadecyl-N,N-dimethylammonium chloride, N,N-di(tetradecyl)-N,N-dimethylammonium chloride, and N,N-di(pentadecyl)-N,N-dimethylammonium chloride).

Another suitable quaternary ammonium compound has the formula R¹⁹R²⁰(CH₃)₂N⁺X⁻, where R¹⁹ is a substituted or unsubstituted benzyl group, R²⁰ is linear C₁₀ to C₂₀ saturated or unsaturated group, and X is defined as above. According to a preferred embodiment, R¹⁹ is benzyl, R²⁰ is a linear C₁₂-C₁₈ saturated or unsaturated group, and X is chloride. Examples of such compounds include, but are not limited to, a mixture of N—(C₁₂-C₁₆)alkyl-N-benzyl-N,N-dimethylammonium chloride, which is available as Barquat® MB from Lonza, Inc. of Fair Lawn, N.J.; and N-octadecyl-N-benzyl-N,N-dimethylammonium chloride, which is available as Carsoquat® SDQ from Lonza Inc.

Another quaternary ammonium compound contemplated for use in the present invention has the formula R¹⁹R²⁰N⁺(CH₃)(CH₂CH₂O)ₙH X⁻ where R¹⁹ is a C₆-C₂₀ linear or branched, substituted or unsubstituted alkyl group or a C₆-C₂₀ substituted or unsubstituted aryl group, R²⁰ is a C₁-C₂₀ linear or branched, substituted or unsubstituted alkyl group or a C₆-C₂₀ substituted or unsubstituted aryl group, n is an integer from 1 to 2, and X is defined as above. Preferably, R¹⁹ and R²⁰ are linear or branched C₈-C₁₀ substituted or unsubstituted groups and more preferably are decyl. X is preferably propionate. An example of such a compound is N,N-didecyl-N-methyl-N-hydroxyethylammonium proprionate, available as Bardap® 26 from Lonza, Inc. of Fair Lawn, N.J.

Yet another suitable quaternary ammonium compound has the formula R¹⁹R²⁰R²¹(CH₃)N⁺X⁻, where R¹⁹, R²⁰, and R²¹ independently are linear or branched C₆-C₂₂ saturated or unsaturated groups. More preferably R¹⁹, R²⁰, and R²¹ independently are linear or branched C₈-C₁₀ saturated or unsaturated groups. X is preferably chloride. Examples of such compounds include, but are not limited to, N,N,N-tri(octyl/decyl)-N-methylammonium chloride, which is available as Aliquat® 336 from Aldrich Chemical Company of Milwaukee, Wis. (Aliquat® 336 is a mixture of N,N,N-tri(octyl)-N-methylammonium chloride, N,N-di(octyl)-N-decyl-N-methylammonium chloride, N-octyl-N,N-di(decyl)-N-methylammonium chloride, and N,N,N-tri(decyl)-N-methylammonium chloride.

The polymeric quaternary ammonium biocide may be any known in the art. Suitable polymeric quaternary ammonium biocides include, but are not limited to, poly[oxyethylene(dimethyliminio)ethylene-(dimethylimino)ethylene dichloride]; reaction products of epichlorohydrin and dimethylamine; and mixtures thereof.

More preferred quaternary ammonium biocides include, but are not limited to, benzalkonium chloride and didecyl dimethyl ammonium chloride.

The biocidal amine or salt thereof may be any known in the art. Suitable amines include, but are not limited to, those having the formula NR⁷R⁸R⁹ where R⁷, R⁸, and R⁹ are independently hydrogen, alkyl (such as C₁-C₃₀ alkyl), or aryl and R⁷, R⁸, and R⁹ are optionally substituted with an amino group (—NH₂). According to one preferred embodiment, R⁷ is a C₁-C₁₈ alkyl and R⁸ and R⁹ are methyl (e.g., dodecyldimethyl amine). According to another preferred embodiment, R⁷ is a C₁-C₁₈ alkyl and R⁸ and R⁹ are —(CH₂)₃NH₂ (e.g., bis(3-aminopropyl)dodecylamine, which is available as Lonzabac® 12 from Lonza Inc. of Fair Lawn, N.J.). Suitable salts of these amines include, but are not limited to, hydrochloric, hydrobromic, and sulfuric salts.

The free halogen-generating biocide, halogen stabilizer, and quaternary ammonium biocide and/or biocidal amine may be directly added to the aqueous solution in any order or simultaneously. Two or more of the free halogen-generating biocide, halogen stabilizer, and quaternary ammonium biocide may be mixed prior to addition to the aqueous solution. For example, the free halogen-generating biocide and a mixture of the halogen stabilizer and quaternary ammonium biocide and/or biocidal amine may be separately added to the aqueous solution. The halogen stabilizer/biocide mixture preferably is a single phase solution. If phase separation occurs, the halogen stabilizer and/or biocide are no longer uniformly distributed throughout the mixture. In systems where the halogen stabilizer/biocide mixture is stored in a container and pumped from the top or bottom of the container into an aqueous solution, this may result in an undesirable ratio of halogen stabilizer to biocide being added to the aqueous solution. The single phase solution is preferably phase stable at 4° C. for at least 3 or 5 days and/or phase stable at 50° C. for at least 30 days. The phase stability of a halogen stabilizer/quaternary ammonium biocide mixture may be improved by the addition of an amine oxide, such as a (C₈-C₂₂ alkyl)dimethyl amine oxide.

According to one preferred embodiment, a mixture of the halogen stabilizer and quaternary ammonium biocide and/or biocidal amine is provided and mixed with the free halogen-generating biocide prior to being added to the aqueous solution. Preferably, the free halogen-generating biocide is mixed with the halogen stabilizer/biocide mixture just prior to being added to the aqueous solution. The mixture of halogen stabilizer and quaternary ammonium biocide and/or biocidal amine generally contains from about 1 to about 50% or 99% by weight of halogen stabilizer and from about 1 to about 99% of quaternary ammonium biocide and/or biocidal amine, based upon 100% weight of total mixture. According to one embodiment where the halogen stabilizer is DMH, the mixture in concentrated form contains broadly from about 1 to about 50%, preferably from about 2 to about 25%, and more preferably from about 5 to about 10% by weight of DMH and from about 1 to about 99%, preferably from about 2 to about 50%, and more preferably from about 5 to about 25% by weight of quaternary ammonium biocide and/or biocidal amine, based upon 100% weight of total mixture.

According to another preferred embodiment, a mixture of the halogen stabilizer, quaternary ammonium biocide and/or biocidal amine, and a bromide source is provided. The mixture is either applied directly to the aqueous solution together with the free halogen-generating biocide or mixed with the free halogen-generating biocide prior to being added to the aqueous solution. Preferably the mixture contains from about 1 to about 50% by weight of the bromide source.

Any of the free halogen-generating biocides, halogen stabilizers, and quaternary ammonium biocides maybe mixed with non-aqueous solvents and other adjuvants known in the art, prior to their addition to the aqueous solution. Any mixtures can be prepared by mixing the appropriate ingredients. The mixtures may be heated and/or stirred to expedite mixing.

The molar ratio of free halogen-generating biocide to halogen stabilizer maintained in the aqueous solution broadly ranges from about 20:1 to about 0.2:1 and preferably ranges from about 10:1 to about 0.9:1. The molar ratio of halogen stabilizer to quaternary ammonium biocide and/or biocidal amine maintained in the aqueous solution broadly ranges from about 50:1 to about 0.02:1 and preferably ranges from about 10:1 to about 0.1:1.

When the halogen stabilizer is DMH, the weight ratio of DMH to quaternary ammonium biocide and/or biocidal amine maintained in the aqueous solution broadly ranges from about 100:1 to about 1:100 and preferably from about 50:1 to about 1:50. For example, when the quaternary ammonium biocide is benzalkonium chloride, the weight ratio of DMH to benzalkonium chloride maintained in the aqueous solution broadly ranges from about 100:1 to about 1:100 and preferably from about 50:1 to about 1:50. When the quaternary ammonium biocide is didecyl dimethyl ammonium chloride, the weight ratio of DMH to didecyl dimethyl ammonium chloride maintained in the aqueous solution broadly from about 100:1 to about 1:100 and preferably from about 50:1 to about 1:50.

The concentration of free halogen-generating biocide, halogen stabilizer, and quaternary ammonium biocide and/or biocidal amine maintained in the aqueous solution generally is a biocidally, algicidally, fungicidally, or bactericidally effective amount. According to one embodiment, the concentration of total oxidizing halogen biocidal species broadly is from about 0.05 to about 10 ppm, the concentration of halogen stabilizer broadly is from about 0.01 to about 100 ppm, and the concentration of quaternary ammonium biocide and/or biocidal amine broadly is from about 0.01 to about 100 ppm. According to one preferred embodiment, the concentration of total oxidizing halogen biocidal species is from about 0.1 to about 5 ppm, the concentration of halogen stabilizer is from about 0.1 to about ppm, and the concentration of quaternary ammonium biocide is from about 0.1 to about 5 ppm.

The aqueous solution may be, for example, water in a swimming pool or spa, a water treatment facility, a toilet, a pulp slurry, a papermaking slurry, a mineral slurry or white water. White water is generally separated liquid that is re-circulated to a preceding stage of a papermaking process, especially to the first disintegration stage, where paper, water and chemicals are mixed.

Typical pulp slurries in paper applications contain from about 0.2 to about 18% by weight of organic matter, based upon 100% total weight of slurry. The organic matter is typically comprised of wood fiber (or pulp) and adjuvants, such as sizing and starch. Generally, the organic matter comprises from about 90 to about 99% by weight of wood fiber (or pulp), based upon 100% total weight of organic matter. According to a preferred embodiment, the wood fiber is at least partially derived from recycled paper.

The aqueous solution (e.g., pulp slurry) may also contain other adjuvants known in the art. Examples of such adjuvants include, but are not limited to, other biocides and/or slimicides; sodium hydroxide (or other caustic); peroxide stabilizers, such as sodium silicate, magnesium sulfate, and polyphosphates; chelating agents, such as EDTA; fatty acids; and combinations thereof.

The following examples illustrate the invention without limitation. All parts and percentages are given by weight unless otherwise indicated.

### EXAMPLE 1

The ingredients in Table 1 below were added to a 25 ml flask and monitored for phase and color stability. As shown by Table 1, DMH produces phase and color stable solutions with Bardac® 1552 and poly[oxyethylene(dimethyliminio)ethylene-(dimethyliminio)ethylene dichloride].

TABLE 1

| Aqueous Solution | | | |
|---|---|---|---|
| containing 15% | | | |
| (w/w) DMH | Quaternary Ammoniuim | Observations | |
| (pH = 9.5) | Biocide | Color | Phases |
| 7.5 g | 7.5 g Bardac ® 1552¹ | Water white- | 1 |
| | | clear | |
| 7.5 g | 7.5 g Biolab ® Algae All | Light brown- | 1 |
| | 60² | clear | |

¹Bardac ® 1552 is an aqueous solution containing 50% (w/w) of a mixture of N-alkyl(C₁₄ 60%; C₁₆ 30%; C₁₂ 5%; C₁₈ 5%) dimethyl benzyl ammonium chloride and di-N-alkyl(C₁₄ 60%; C₁₆ 30%; C₁₂ 5%; C₁₈ 5%) methyl benzyl ammonium chloride available from Lonza Inc. of Fair Lawn, NJ.
²Biolab ® Algae All 60 is an aqueous solution containing 60% (w/w) of poly[oxyethylene(dimethyliminio)ethylene(dimethyliminio)ethylene dichloride] available from Bio-Lab, Inc. of Decatur, GA.

### EXAMPLE 2

The low and moderate temperature phase stability and high temperature compositional stability of the N-hydrogen compound/quaternary ammonium aqueous compositions shown in Table 2 was determined as follows. The N-hydrogen compounds were hydantoins. Some of the compositions also include an amine oxide.

Low temperature phase stability was determined by placing prepared formulations in 4° C. storage for 3-5 days followed by visual observation. Acceptable formulations remained as single-phase solutions with no phase separation or crystallization.

Moderate temperature phase stability was defined as the ability to prepare a single-phase solution at room temperature with the composition.

High temperature compositional stability was determined by placing prepared formulations in storage at 50° C. for approximately 30 days followed by hydantoin analysis by HPLC. Acceptable formulations remained as single-phase solutions with hydantoin recovery of greater than 90%.

The results are shown in Table 2.

TABLE 2

| Quaternary | | | | | |
|---|---|---|---|---|---|
| Ammonium | | | | | |
| Compound and | | | | | |
| Amine Oxide | | | | | |
| (% Active | | | | | |
| Ingredient (AI) | Hydantoin | | | | |
| in Total | (% wt in | Temperature Stability | | | |
| Composition) | composition) | Low | Moderate | High | Overall |
| Bardac ® 22 | 7.5% DMH¹ | Fail | — | — | Fail |
| (25% AI) | | | | | |
| WSCP (30% AI) | 7.5% DMH¹ | Pass | Pass | Pass | Pass |
| Barquat ® 1552 | 7.5% DMH¹ | Pass | Pass | Pass | Pass |
| (25% AI) | | | | | |
| Barquat ® 1552 | 6.0% | Pass | Pass | Pass | Pass |
| (16% AI) | DMH/MEH⁴ | | | | |
| Barquat ® 1552 | 11.9% | Pass | Fail | Pass | Mar- |
| (32% AI) | DMH/MEH⁴ | | | | ginal |
| Bardac ® 22 | 6.4% | Fail | — | — | Fail |
| (13% AI) | DMH/MEH⁴ | | | | |
| Bardac ® 22 | 10.3% | Fail | — | — | Fail |
| (21% AI) | DMH/MEH⁴ | | | | |
| Bardac ® 22 | 6.4% | Pass | Pass | Pass | Pass |
| (13% AI) and | DMH/MEH⁴ | | | | |
| Octyldimethyl amine | | | | | |
| oxide (2%) | | | | | |
| Bardac ® 22 | 10.3% | Pass | Pass | Pass | Pass |
| (21% AI) and | DMH/MEH⁴ | | | | |
| Octyldimethyl amine | | | | | |
| oxide (2%) | | | | | |

¹The tested solution was prepared with crystallized DMH.
²Bardac ® 22 is a solution containing 50% N,N-didecyl-N,N-dimethylammonium chloride, 20% isopropanol, and 30% water and is available from Lonza Inc. of Fair Lawn, NJ.
³WSCP is a 60% active aqueous solution of poly[oxyethylene(dimethyliminio)ethylene-(dimethyliminio)ethylene dichloride] available as Buckman Bulab 6002 from Buckman Laboratories International Inc. of Memphis, TN.
⁴The weight ratio of DMH:MEH is 5:1. The tested solution was prepared with crystallized DMH and MEH.

### EXAMPLE 3

The slimicidal efficacy of the Barquat 1552®/DMH/NaOCl compositions recited in Table 3 below was evaluated with white water obtained from a U.S. northeastern tissue mill. The pH of the white water was about 7.5. The test organisms were those native to the white water.

Bardac® 1552 master biocide solutions were prepared such that the addition volume of quaternary stock solution was between 0.1 and 2.0 mls to the 50 ml test volume. Master solutions of DMH were prepared in combination with NaOCl at a 1:1 molar ratio such that the addition volume of stock solution was between 0.1 and 2.0 mls to the 50 ml test volume. The appropriate volumes of these stock solutions were utilized to generate the active concentrations recited in Table 3 below.

A sufficient amount of the Barquat 1522® master biocide solution and DMH master solution were added to the white water to obtain the concentrations of Barquat 1522® , DMH, and NaOCl in the white water indicated in Table 3. The white water was then incubated for 3 hours at 37° C. The test conditions were based on ASTM E 1839-96. Microbiological counts were performed using tryptone glucose extract agar by known pour plate techniques. DIFCO D/E Neutralizing Broth was used as the first serial dilution tube for biocide neutralization. Under the conditions of ASTM E 1839-96, slimicidal efficacy is demonstrated upon the achievement of a bacterial reduction of 99% (2 Logs).

TABLE 3

| | | | | Change in | |
|---|---|---|---|---|---|
| Barquat ® | | | Log of | Log of | |
| 1552 | | | Micro- | Micro- | |
| (ppm of | | | biological | biological | |
| ammonium | DMH | NaOCl | Count | Count | Slimicidal |
| chloride) | (ppm) | (ppm) | (log cfu/ml) | (log cfu/ml) | Efficacy |
| 0 | 0 | 0 | 6.2 | — | — |
| 0 | 0 | 5.2 | 4.3 | 1.9 | Fail |
| 0 | 0 | 0 | 6.3 | — | — |
| 13.5 | 4.5 | 2.6 | 2.7 | 3.6 | Pass |
| 20.3 | 6.8 | 3.9 | 2.3 | 4.0 | Pass |
| 0 | 0 | 0 | 7.2 | — | — |
| 5.0 | 4.5 | 2.6 | 4.0 | 3.1 | Pass |
| 7.5 | 4.5 | 2.6 | 3.3 | 3.8 | Pass |
| 7.5 | 6.8 | 3.9 | 3.4 | 3.8 | Pass |
| 0 | 0 | 0 | 7.2 | — | — |
| 5.0 | 4.5 | 2.6 | 4.0 | 3.1 | Pass |
| 7.5 | 4.5 | 2.6 | 3.3 | 3.8 | Pass |
| 7.5 | 6.8 | 3.9 | 3.4 | 3.8 | Pass |

All patents, applications, articles, publications, and test methods mentioned above are hereby incorporated by reference.

Many variations of the present invention will suggest themselves to those skilled in the art in light of the above detailed description. Such obvious variations are within the full intended scope of the appended claims.

In the claims:

1. A method for controlling the growth of microorganisms or killing microorganisms in an aqueous solution, the method comprising adding an effective amount of
(a) a free halogen-generating biocide and
(b) a first mixture of (i) a halogen stabilizer, (ii) a quaternary ammonium biocide, a biocidal amine or salt thereof, or a mixture thereof, and optionally (iii) a bromide source,
to the aqueous solution to control the growth of or kill the microorganisms, wherein the free halogen-generating biocide is added to the aqueous solution separate from the first mixture or in an admixture with the first mixture, the admixture being formed just prior to being added to the aqueous solution.

2. The method of claim 1, wherein the free halogen-generating biocide is a slimicide.

3. The method of claim 1, wherein the free halogen-generating biocide is hypochlorites, hypobromites, chlorine gas, bromine, bromine chloride, halogenated cyanurates, dihalogenated hydantoins, and mixtures thereof.

4. The method of claim 3, wherein the hypochlorite is an alkali metal hypochlorite, alkaline earth metal hypochlorite, or mixture thereof.

5. The method of claim 4, wherein the hypochlorite is sodium hypochlorite.

6. The method of claim 3, wherein the free halogen-generating biocide is a mixture of sodium hypochlorite and sodium bromide.

7. The method of claim 1, wherein the halogen stabilizer is an N-hydrogen compound.

8. The method of claim 7, wherein the N-hydrogen compound is 5,5-dimethylhydantoin, 5-methyl-5-ethyl hydantoin, glycouril, sulfamide, trisulfamide, p-toluene-sulfonamide, melamine, sodium triamidometaphosphate, a 5,5-alkylhydantoin, methanesulfonamide, barbituric acid, 5-methyluracil, imidazoline, pyrrolidone, acetanilide, acetamide, N-ethylacetamide, phthalimide, benzamide, succinimide, cyanamide, urea, N-methylolurea, N-methylurea, acetylurea, biuret, methyl allophanate, methyl carbamate, phthalohydrazide, pyrrole, indole, formamide, N-methylformamide, dicyandiamide, ethyl carbamate, 1,3-dimethylbiuret, methyl phenyl biuret, 4,4-dimethyl-2-oxazolidinone, 6-methyluracil, 2-imidoazolidone, ethylene urea, 2-pyrimidone, N-ethylacetamide, azetidin-2-one, 2-pyrrolidone, caprolactam, phenyl sulfinimide, phenyl sulfinimidylamide, diphenyl sulfonimide, dimethyl sulfinimine, isothiazolene-1,1-dioxide, orthophosphoryl triamide, pyrophosphoryl triamide, phenyl phosphoryl-bis dimethyl amide, boric acid amide, hydantoin, pyrrole, sulfamic acid, ammonia, ammonium bromide, or a mixture thereof.

9. The method of claim 8, wherein the N-hydrogen compound is 5,5-dimethylhydantoin.

10. The method of claim 1, wherein the quaternary ammonium biocide is selected from
(i) a quaternary ammonium biocide having the formula N⁺R¹R²R³R⁴ X⁻ where R¹ and R² are independently unsubstituted or hydroxy substituted linear or branched C₁-C₄ alkyl, —(CH₂CH₂O)ₘCH₂CH₂OH, or —(CH₂CHCH₃O)ₘCH₂CHCH₃OH where m is 1 to 10; R³ is a substituted or unsubstituted benzyl, ethylbenzyl, methylnaphthyl, or linear or branched C₁-C₂₂ alkyl; R⁴ is —R⁵(O)ₙ(C₆H₅)R⁶ where n is 0 or 1; R⁵ is a substituted or unsubstituted C₁-C₈ alkyl or C₁-C₈ alkoxyalkyl; R⁶ is hydrogen or a substituted or unsubstituted, linear or branched C₁-C₁₂ alkyl; and X⁻ is an anoin;
(ii) a quaternary ammonium biocide having the formula R¹⁹R²⁰R²¹R²²N⁺X⁻, where R¹⁹, R²⁰, R²¹, and R²² are independently linear, branched, cyclic or any combination thereof saturated or unsaturated groups, X is an anion, and the sum of the number of carbon atoms in R¹⁹, R²⁰, R²¹, and R²² broadly ranges from about 10 to about 50;
(iii) a polymeric quaternary ammonium biocide; and
(iv) a mixture thereof.

11. The method of claim 10, wherein the quaternary ammonium biocide is benzalkonium chloride, didecyldimethyl ammonium chloride, or a mixture thereof.

12. The method of claim 10, wherein the polymeric quaternary ammonium biocide is poly[oxyethylene(dimethyliminio)ethylene-(dimethyliminio)ethylene dichloride].

13. The method of claim 10, wherein the polymeric quaternary ammonium biocide is a reaction product of epichlorohydrin and dimethylamine.

14. The method of claim 1, wherein the biocidal amine has the formula NR⁷R⁸R⁹ where R⁷, R⁸, and R⁹ are independently hydrogen, alkyl, or aryl and R⁷, R⁸, and R⁹ are optionally substituted with an amino group.

15. The method of claim 1, wherein the biocidal amine is dodecyldimethyl amine, bis(3-aminopropyl)dodecylamine, or a salt thereof.

16. The method of claim 1, wherein the bromide source is sodium bromide, potassium bromide, ammonium bromide, hydrobromic acid, or a mixture thereof.

17. The method of claim 1, wherein the free halogen-generating biocide is added in an admixture with the first mixture, the admixture being formed just prior to being added to the aqueous solution.

18. The method of claim 1, wherein the free halogen-generating biocide is added to the aqueous solution separate from the first mixture.

19. A method for controlling the growth of microorganisms or killing microorganisms in an aqueous solution, the method comprising adding an effective amount of (a) a free halogen-generating biocide, (b) a halogen stabilizer, and (c) a quaternary ammonium biocide, a biocidal amine or salt thereof, or a mixture thereof to the aqueous solution to control the growth of or kill the microorganisms.
